(19) United States
(12) Patent Application Publication
(10) Pub. No.: US 2019/0299297 A1
(43) Pub. Date: Oct. 3, 2019

(54) CUTTING TOOL HAVING SILICONIZED SILICON CARBIDE SHANK CONNECTED TO DIAMOND CUTTING HEAD VIA VACUUM-BRAZED THERMAL INTERFACE

(71) Applicant: WolvertonBailey Tech Fund 1, LLC, Santa Rosa, CA (US)

(72) Inventor: James A. Austin, Lompoc, CA (US)

(21) Appl. No.: 15/936,718

(22) Filed: Mar. 27, 2018

(51) Int. Cl. B23B 27/14

(52) U.S. Cl. CPC B23B 27/148; B23B 2226/72; B23B 2226/31

(57) ABSTRACT

A rotating cutting tool having a shank composed of siliconized silicon carbide (SiSiC), and a diamond cutting head that is mechanically connected to and in thermal communication with the shank via a vacuum-brazed thermal interface.

### CROSS-REFERENCE TO RELATED APPLICATIONS

This application claims priority to U.S. Provisional Patent Application No. 62/477,224 (filed Mar. 27, 2017), which is hereby incorporated by reference in its entirety.

### TECHNICAL FIELD

Embodiments relate to a cutting tool having a shank composed of siliconized silicon carbide (SiSiC) that is connected to diamond cutting head via a vacuum-brazed thermal interface.

### BACKGROUND

When single-crystal diamonds are used to manufacture components specifically within the ultra-precision (e.g., to produce mirror-like surface quality and having exacting surface accuracy) machining disciplines referred to as diamond-turning and diamond-flycutting, the acceptable wear mechanism at the cutting edge is “graphitization,” which may only occur in the presence of oxygen and at temperatures above 482° C. (900° F.).

From the publication “The Kinetics of the Diamond—Oxygen Reaction” by T. Evans and C. Phaal, from the Physics Department, University of Reading, England (Aug. 8, 1961), one may understand that: (1) single-crystal diamonds wear via “graphitization” in an experiment where diamonds of {100} and {110} crystallographic orientation were subjected to a hot (700° C.) stream of purified oxygen gas, directed parallel across the crystal faces, and (2) the {100} plane is more resistive to this parallel, “sliding” wear mechanism than is the {110} plane.

In one instance, the graphitization temperature threshold was discovered to be 482° C. (900° F.), and that for the perpendicular (oxygen streaming directly at the test crystal) “impinging” wear mechanism, the {110} plane was more resistive to wear than the {100} plane.

In the publication “F2, H2O, and O2 etching rates of diamond and the effects of F2, HF and H2O on the molecular O2 etching of {110} diamond” by C. J. Chu et al. of Rice University (Tex.) Department of Chemistry, discloses that graphitization initiates at some temperature of less than 600° C.

Conventional machining takes place in a machine shop, and is generally performed on lathes, mills and other equipment at room temperature and normal atmospheric pressure. A machinist will set-up, program, initiate, and monitor the machining process, and are required to remain in the vicinity of their equipment during the machining process.

When a machinist needs a cutting tool, an appropriate tooling bar or shank will be required in which to an appropriate cutting head, tip, or insert (having a cutting edge that is to dig into the workpiece) is affixed to the shank/tooling bar. The shank with the affixed cutting insert is then fastened to a tool post of the lathe. This is how a cutting edge is attached to a conventional lathe that directs the cutting tips' cut depth and toolpath.

In traditional machining best practices, the shank/tooling bar is used for positioning, anti-chatter, and anti-vibration during operation of the cutting tool. The shank/tooling bar must be rigid, i.e., have a modulus of elasticity that is large in magnitude so that cutting edge vibration or “chatter” is eliminated or at least minimized. A shank/tooling bar composed of tungsten carbide (WC) is conventionally used for machining operations requiring optimized stiffness, and is also inexpensive. The technology and science of tungsten carbide is so highly advanced that the insert can also be made of solid “carbide.” In this regard, it bears noting that a variant of tungsten carbide is available (deemed HD 17.7 Tungsten) that is “enhanced” to provide thermal conductivity as high as 113 W/m²K.

The insert is attached mechanically by a single screw, which is acceptable for traditional machining, but is not optimal for precision diamond machining. Single screw mounting cannot guarantee that there will be a solid, non-yielding, non-vibrating attachment of the insert to the shank.

In conventional machining, keeping the cutting insert and/or the workpiece from overheating during the machining process is mitigated via application of large volumes of high-pressure, refrigerated coolant utilized to extend the life of the cutting edge of the diamond insert. A science has developed to encompass all the technical discoveries with respect to the chemistry and temperature of the coolants/lubricants and the methods of their application/delivery during the conventional machining process. In diamond-turning and flycutting, coolants (including just directing a low-pressure stream of air across the cutting edge) and lubricants applied as a mist, must be applied carefully. Since a typical depth of cut for diamond-turning and flycutting of 2 microns (80 millionths of an inch) is very shallow, the use of cold, fluid coolant at the cutting edge to the workpiece interface (as in traditional machining) is undesirable in that it may result in vibration. Such vibration may in turn cause higher values of roughness, and/or thermal shrinkage of the workpiece. Consequently, this will result in unwanted figure accuracy variations. Not only is figure accuracy in jeopardy, but surface quality is also diminished. The dynamics of material removal, especially when diamonod-machining engineering crystals, begins to degrade as the cutting edge loses its sharpness. This normally requires the operator to intervene and change to a fresh, sharp diamond cutting tool.

In diamond-turning and flycutting operations, surface finish specifications are measured in Angstroms. One reason that a solid, single-crystal diamond (about the size of a one-third carat engagement ring stone) is used as the cutting head is that the surface quality (roughness) requirements are very demanding in diamond-turning and flycutting. An “8” (8 microinch Ra or roughness average) finish is very smooth for traditional machining, whereas 20 Angstroms Rq (less forgiving than Ra), (or what would be a “0.08” machinist finish, two orders of magnitude better) is good surface quality for diamond turning. As a result, it must be understood that the “diamond” in diamond-turning is used because it can be sharpened/polished to the degree that a typical callout for good sharpening quality is “chip free edge at 800 power magnification.” In fact, in some instances, a 90 degree section of cutting edge can be chip-free at 20,000 power magnification (as measured by an electron microscope).

A diamond head with any measureable wear is quickly approaching the point where it must be removed in favor of a sharp one. The erosion at the top edge and front of the diamond cutter, as the result of graphitization, causes the graphitized surfaces to physically recede, and thus, effect the surface figure accuracy of the workpiece (the diamond cutting edge is no longer in its programmed position). When the worn area of the cutting edge (from the front) is inspected in electron microscopes or other high-powered microscopes using differential interference contrast, it appears as a microscopic veil or a waterfall.

The front (or clearance face) of the diamond is typically either a cylinder or a cone, and the top (or rake face) of the diamond is usually a flat plane, so the intersection of the curved front and the flat top of the diamond is a segment of a circle or an ellipse. The clearance face and the rake face can be ground and polished by skillful technicians so that the cutting edge is within +/−1 microinch of a perfect circle.

The diamond head or insert must be removed and replaced with a new or re-sharpened one should it suffers a chip along the cutting edge. The diamond cutting edge is useless if it suffers even one small chip that is one micron in size. This is because a small chip in the cutting edge would cause a repetitive peak and valley in the surface of the workpiece being diamond-machined, which would immediately violate the surface finish specification of the customer.

There are numerous small chips (greater than one micron in size) in the cutting edge of a conventional machinists cutting head, as it comes from the vendor as brand-new. Neither is the accuracy of any radius as near perfect.

Diamond-turning surface figure requirements are measured in fractions of a wavelength of red laser light (one wavelength of red laser light≈25 millionths of one inch). A typical blueprint callout for diamond-turned optical surface figure accuracy is ¼ of that 25 millionths (i.e., “quarter wave”), but some customers require 1/10 wave. “Wave” is parlance for one wavelength in the industry. So, a manufacturer of diamond-turned components must understand that its error budget is almost always less than 25 millionths of an inch.

A non-traditional machining process, diamond machining (including ruling, turning and fly cutting) where a sculpted single-crystal diamond is the cutting edge, originated in traditional machining, but quickly outgrew it. The use of traditional ball or roller bearing spindles were eliminated in favor of air-bearing spindles with 1 microinch total run-out (roundness). Oil-hydrostatic slideways replaced traditional bearing slides that require some “clearance or looseness” in order to allow for movement. Allowing even 1 micron of looseness, in roller or ball bearing applications in a diamond-turning machine, would defeat the very tight tolerances that customers require. For the same reason, leadscrew slide-drive mechanisms were replaced with non-contact, linear motors (magnetic drive devices). The air-bearing spindles are even driven by integrally mounting the permanent magnets of a brushless DC motor directly to the rotating element of the spindle, so that the driving force causing rotation, is purely magnetic.

Diamond machining is also non-traditional because it requires that the process, and even the machine's temperature, be held at ± (plus or minus) 1° F. or better. This is important because the required tolerances for figure accuracy and surface quality of the components produced by diamond-turning are much more stringent. Tight figure accuracy tolerances in traditional machining may be +/− two ten-thousandths of an inch or 0.0002 inches, but (as described herein) in diamond turning, +/−6 microinches (0.000006″) is a more normal tolerance, with +/−2 microinches (millionths of an inch) as a tighter tolerance sometimes required by the customer. Steel (of which the diamond-turning machine is mostly made) expands 7 millionths of an inch per ° F. per inch of thickness. Aluminum (a popular raw material for telescope mirrors) expands 13 millionths of an inch per ° F. per inch of thickness. This is why the diamond-turning process must be tightly controlled from a thermal perspective. If the workpiece being machined is allowed to shrink and swell to a certain degree due to thermal expansion and contraction of anything in the process (including the diamond-turning lathe itself), then those tight tolerances may be violated.

Another fact that sets diamond-machining apart is that acceptable diamond head edge wear is only as a result of “graphitization.” This only occurs when the outermost (surface) molecules of a diamond are exposed to moving material contact (friction), causing localized temperatures exceeding 900° F. (482° C.) in the presence of oxygen. The word “localized” is important to understand. Even though 482° C. is being developed by the cutting process, the area of contact is so small and localized that the heat generated there does not contribute to thermal expansion of the workpiece. The heat generated at the tool head-to-part interface is more quickly spread to the volume of the diamond (which is the best conductor of heat of all known materials at 2200 W/m²K).

The temperature of the diamond head where the workpiece and the chips contact the diamond head may exceed 482° C. Diamond converts to graphite above 482° C., and in the presence of oxygen (O₂), the graphite is swept away by the process (graphite does not convert back to diamond). Just one pass, removing 2 microns from one side of a 2″ diameter, ¼″ thick piece of copper, is enough to develop microscopic but measurable wear on the rake face, cutting edge, and clearance face of the diamond head. So the diamond head exhibits graphitization at these areas where the operational temperature exceeds 482° C. Since a diamond head with a shank composed of HD 17.7 Tungsten material (having a thermal conductivity of 113 W/m²K) begins to graphitize and develop wear areas via cutting friction/heat, heat is not transferred from the diamond head quickly enough from the contact area, and thus, builds up in the diamond head. This heat build up results in graphitization, which makes the diamond head cutting head lose its sharpness. Please note that a “sharp” diamond head cutting edge has a 2 microinch (2 millionths of an inch) radius at its cutting edge. Only single-crystal diamond can be made this sharp and chip-free.

The thermal conductivity of (non-enhanced) Silicon Carbide is 100 W/m²K. It has industrial applicability as a heat sink, but has not been tested as a diamond head shank. It also does not work to limit graphitization of diamonds. For instance, even single-crystal SiC is not a sufficient heat sink to limit diamond head wear. Testing has revealed another enhanced SiC material that has a thermal conductivity of 150 W/m²K.

A simplified explanation of graphitization is provided here. As the cutting edge of the diamond head contacts/enters the workpiece, in order to remove some material, friction and chip deflection friction must necessarily occur. Accordingly, wear of the diamond head occurs at the cutting edge, but also on the rake face surface behind the cutting edge, where the material being removed contacts the top of the diamond head and is deflected away. During operation, the diamond head may travel at speeds of 78 ft/s, such that frictional heat is generated during at the contact area/region (141.5 microns or 0.006″ in length) between the diamond head and the workpiece. Contact, and therefore, friction occurs behind and below the cutting edge, and significant heat is thereby generated.

It is important to note that the amount of operational wear (e.g., just a few tenths of a micron) experienced by the diamond head cutting edge means the once-sharp cutting edge is now becoming dull. In turn, replacement of diamond head is required since a dull cutting edge will produce higher values of roughness, and the diamond will wear faster as the edge dulls. As the cutting edge wears, more contact surface area of the cutting head and the workpiece results. More surface contact means more heat will be generated due to friction, yielding more wear.

Scientists, engineers, and machinists have worked on the problem of limiting graphitization in different ways. One attempted solution involved immersing the workpiece, the diamond head, the shank, and a portion of the post in liquid nitrogen (LN2). While this served to significantly reduce graphitization, it is impractical. Moreover, although graphitization can be controlled where immersion in LN2 keeps the temperature down and the oxygen away, the reduction in area of everything immersed in LN2 (due to shrinkage) due to the super-cold LN2, results in geometric accuracies being uncontrollable.

Other solutions involved the application of refrigerated coolants and carbon dioxide “snow”, but were unsuccessful. With the application of other cold coolants via spray nozzle (out into a machine in a normal room environment), heat suppression was insufficient and there was always the presence of oxygen, allowing for graphitization of the diamond. And even in this latter case, figure accuracy of the workpiece still suffered due to drastic thermal variances.

Due to customer demand and requirements, something is needed to minimize or otherwise eliminate (e.g., to less than +/−1 microinch) operational wear of the cutting edge of the diamond.

### SUMMARY

Embodiments relate to a diamond cutting head having a shank and/or insert base composed of a material that is to minimize or otherwise eliminate operational diamond head edge wear. In accordance with embodiments, such a material comprises siliconized silicon carbide. The importance of accuracy in the diamond-machining process results in hours being extended to properly set-up a diamond head, making it ready for production of aspheric optics. Limiting diamond head edge wear would reduce or otherwise eliminate the need to replace the diamond cutter so frequently.

Embodiments also relate to a diamond cutting head having a shank and/or insert base composed of a material that is to make practical the production of larger scale silicon aspheric optics.

Embodiments also relate to a diamond cutting head having a shank and/or insert base composed of a material that is beneficial for use by traditional machinists.

During operation of the cutting tool, frictional heat generated by contact between the cutting tool edge and the workpiece is drawn away from the diamond cutter and distributed to the shank via a thermal interface. The diamond cutter has a very small area thereon where contact is made with the workpiece being diamond-turned. At this contact area, heat is generated and spreads quickly to the bulk of the diamond due to the thermal conductivity of diamond being 2200 W/m²K. For the diamond to braze junction, one heat transfer equation for diamond shows: Q dot (heat flow)=K×A×ΔT, where K is the heat transfer coefficient of diamond (2200 W/m²K), A (which A represents the braze contact area of the diamond to the shank) is about 5 square millimeters (5 millionths of a square meter), the temperature of the diamond head being 482° C., and the temperature of the diamond-to-shank junction area at 200° C. Using this data results in 3.1 watts being transferred at the junction. There is a one micron thick layer of vacuum braze interface, e.g., silver solder, which is configured to atomically bond the diamond cutter to the shank and serves to transfer heat from the diamond cutter to the shank. The heat transfer coefficient of the vacuum braze interface is 400 W/m²K. Because embodiments provide for a thin layer of the vacuum braze interface, it may not need to be considered in the heat transfer equation.

### DRAWINGS

Embodiments will be illustrated by way of example in the drawings and explained in the description hereinbelow.

FIG. 1 is a perspective view of an embodiment of a cutting tool.

FIG. 2 is a side sectional view of the cutting tool, in accordance with embodiments.

FIG. 3 is a block diagram of the cutting tool, in accordance with embodiments.

### DESCRIPTION

Important terms:

Graphitization: The result of heating the exposed surface of a diamond, in the presence of oxygen, to 900° F. (482° C.) via rubbing or friction contact. This specific, hot, impinging, and/or sliding action causes the exposed diamond molecules, in the area of contact, to physically convert from diamond to the stable form of carbon, which is graphite. Once converted to graphite, it is swept away by the friction action, exposing fresh diamond molecules below it. Graphite does not re-convert to diamond.

Coefficient of Thermal Conductivity or Heat Transfer Coefficient: measured in Watts per square Meter Kelvin (W/m²K), and is a measure of how fast heat flows through a given material, from where heat is generated to where heat is extracted. Larger values equates to faster heat flow.

Siliconized Silicon Carbide (SiSiC): a solid material based on silicon carbide (SiC), and is enhanced with 15% pure silicon to produce a significantly greater thermal conductivity (225 W/m²K) than just pure silicon carbide.

Modulus of elasticity: the measure of a materials' elasticity, lower numbers indicate very elastic (bendable), higher numbers indicate a lack of elasticity (rigidity or stiffness), measured in Giga-Pascals (GPa).

Diamond: the solid, single piece having a cutting edge skillfully sculpted, and includes a flat surface specifically produced to provide a mating interface to the shank. The diamond must be skillfully selected for exceptional quality and crystalographically oriented for optimum cutting edge performance. Internal flaws and one specific orientation {111} must be avoided.

Tungsten Carbide (non-enhanced): a man-made material (thermal conductivity of 83 W/m²K) used extensively where high rigidity is desired (Modulus of elasticity=500 GPa). The industrial nickname for this material is “Carbide.”

Silicon Carbide (non-enhanced): SiC is a man-made powdered material that when formed into a solid is used as a heat sink (thermal conductivity of 100 W/m²K).

Thermal expansion and contraction: measured in microinches per ° F., per inch of material thickness. Most materials expand when warmed and contract when cooled. Each material has a known amount of expansion/contraction. This is stated as the materials “coefficient of thermal expansion” or CTE. For example, Steel shrinks or expands 7 millionths of an inch per ° F. per inch of thickness. Aluminum's CTE is 13 millionths of an inch per ° F. per inch of thickness.

Surface Figure Accuracy: The deviation from the perfect, exact, mathematical model, and the actual surface profile produced. Measured in fractions of a wavelength of red laser light.

Surface Roughness (Rq): The microscopic RMS surface texture, with its peaks and valleys, averaged over an area of about ¾ of a square millimeter, measured in Angstroms because that is how smooth the customer needs it to be.

Special units of measure:

1 “Microinch” equals 1 millionth of 1 inch.

1 “Micron” (one one-thousandths of a millimeter) approximately equals 40 millionths of 1 inch.

1 “Angstrom”=1×10⁻¹⁰ meter (or one ten billionth of a meter). 254 Angstroms equal 1 microinch.

1 wavelength or “Wave” of red laser light approximately equals 25 microinches.

Temperatures measured in either Kelvin or the Celsius scale are interchangeable in mathematical calculations.

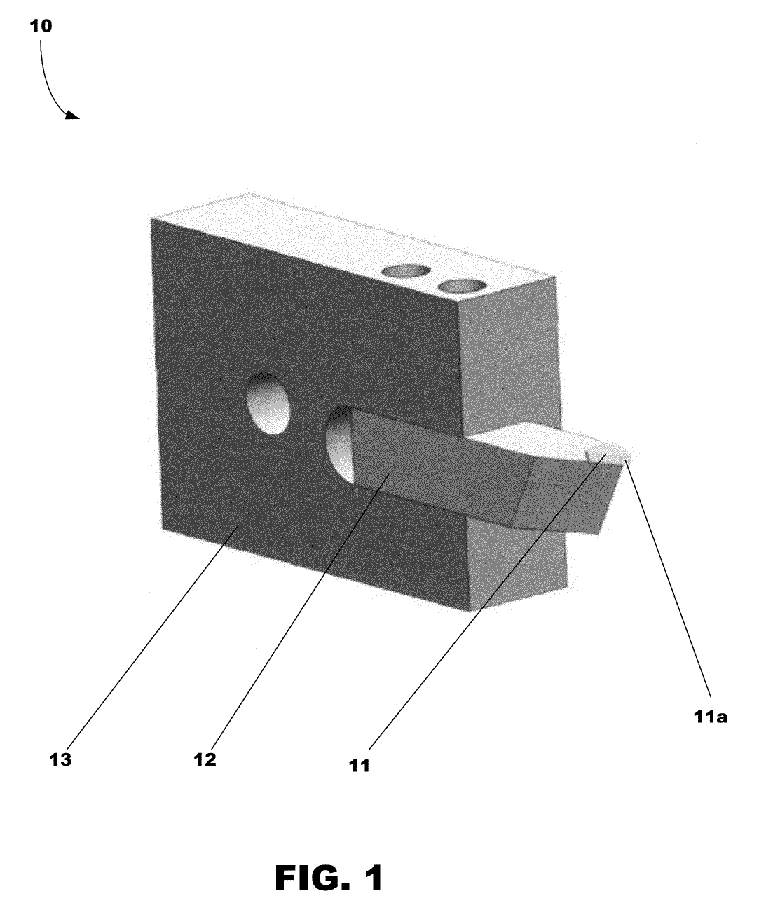

As illustrated in FIGS. 1 to 3, embodiments relate to a cutting tool 10 to perform ultra-precision machining of a workpiece. The cutting tool 10 includes a cutting tool head 11 having a cutting edge 11a to contact the workpiece during a machining operation. In accordance with embodiments, the cutting tool head 11 comprises a single-crystal diamond material. Embodiments are intended to cover diamond-machining processes performed at or near room temperature and atmospheric pressure, and in the presence of oxygen.

A shank 12 is specifically configured to serve as a heat sink which transfers heat H generated by frictional contact between the cutting edge 11a and the workpiece. The shank 12 comprises a shank body connected at one end to a tool post 13 and another end to the cutting tool head 11. In accordance with embodiments, the shank is composed of a material having a predetermined thermal conductivity that permits the transfer of heat from the cutting tool head 11 at a rate sufficient to prevent the operational temperature of the cutting tool edge 11a to exceed 482° C. This advantageously prevents undesirable graphitization, reduces or otherwise eliminates operational wear of the cutting edge 11a caused by graphitization, thereby extending the operating life of the cutting tool head 11. In accordance with embodiments, the predetermined thermal conductivity of such a material is 225 W/m²K. The material may, for example, comprise siliconized silicon carbide (SiSiC). The chemical composition of the shank 12 may be, for example, approximately 85% pure silicon carbide, and approximately 15% pure silicon (with less than approximately 0.05% other materials). The modulus of elasticity the shank 12 should not be less than 340 GPa and its thermal conductivity should not be less than 225 W/m²K. This is in opposition to use of an enhanced tungsten shank that has a maximum thermal conductivity of 113 W/m²K.

Taking into account a 200° C. input, the shank 12, which is composed of SiSiC, is configured to distribute the frictional heat to the tool post, through 1.125 square inches of contact surface, thereby heating the junction surfaces to 30° C. The SiSiC shank dissipates approximately 27.76 W of heat. 225×1.125×170/1550 (1550 square inches to a square meter)=27.76 W dissipated.

Accordingly, use of a shank material having a thermal conductivity that prevents the cutting edge 11a from reaching a predetermined threshold temperature of 482° C. 225 W/m²K will serve to prolong the operational life of a diamond head used for a precision cutting tool. There is a “breakpoint” somewhere between 113 W/m²K and 150 W/m²K, where heat finally travels fast enough so that the diamond head is not heated to the point where the diamonds' cutting edge 11a attains a temperature of 482° C.

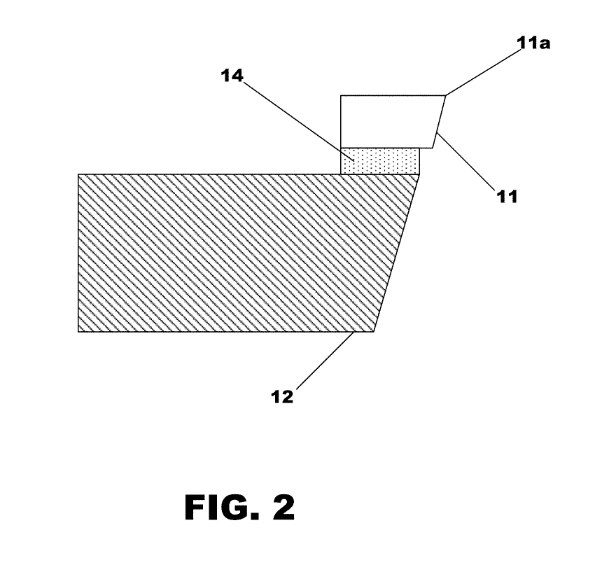

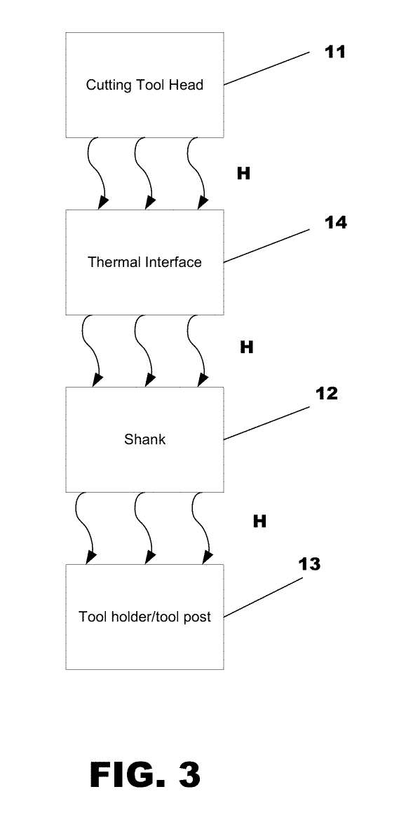

As illustrated in FIGS. 2 and 3, a thermal interface 14 is arranged between the cutting tool head 11 and the shank 12. The thermal interface 14 is configured to form a thermal and physical connection between the cutting tool head 11 and the shank 12. In accordance with embodiments, the thermal interface 14 is configured to serve as a thermal conductor which transfers the frictional heat from the cutting tool head 11 to the shank 12 via heat conduction.

In accordance with embodiments, the thermal interface 14 is composed of a thermal conducting material, such as, for example, a metal material. Such a metal material may comprise, for example, a silver-based alloy which is vacuumed brazed to form a vacuum-brazed connection between the cutting tool head 11 and the shank 12. The metal material should have a thermal conductivity that is greater than the thermal conductivity of the shank 12 but less that the thermal conductivity of the diamond cutting tool head 11. In that way, the thermal interface 14 is configured to quickly transfer heat H from the cutting tool head 11 so that an operational temperature of the cutting edge 11a does not reach or go above the threshold temperature of 482° C. when contacting the workpiece. In accordance with embodiments, a heat-conductive paste is to be applied at any boundary(ies) between the shank 12 and the lathe where heat transfer can be enhanced. The cutting tool head 11 is configured to contact the shank 12 at a single plane of contact interface where atomic bonds are shared.

In operation, the cutting tool 10 is to perform such that heat H is transferred from the diamond cutting tool head 11 to the thermal interface 14, then to the shank 12, and then to the tool-holder/tool post 13.

Practice of embodiments provide for numerous technical advantages. For instance, use of an enhanced SiSiC shank 12 results in quick removal of heat H generated by the diamond cutting tool edge 11a during operation of the cutting tool 10. In that way, the temperature of the cutting edge 11a does not reach or exceed the threshold temperature of 482° C. when contacting the workpiece. Consequently, operational wear caused by graphitization is significantly limited or otherwise eliminated. This thereby extends the operating life of the cutting tool 11, and reduces overall maintenance costs connected to the replacement of cutting tools due to the fact that the entire tool 10 must be removed and sent to the sharpening service. The head is not removed from the shank to facilitate sharpening.

The shank 12, due to it comprising a SiSiC material, limits graphitization of all single-crystal diamonds, natural mined stones, or synthetically grown diamonds. Polycrystalline (PCD) and Chemical Vapor Deposition (CVD) diamond tooling will also be benefitted. It bears noting that PCD diamond heads (and so the cutting edge) cannot be sharpened to much better than “chip free at 250 power magnification” due to ⅓ of the diamond powder being oriented in the {111} cleave plane.

The cutting tool 10 advantageously has a design in which the diamond head 11 and the shank 12 are connected at a single contact surface by a vacuum-brazed connection that also serves as a thermal interface 14. This serves to quickly transfer heat H from the cutting edge 11a of the diamond cutting tool head 11 to the heat sink (i.e., shank 12). The shank 12 may then transfer the heat H to the tool-holder/tool post 13.

In accordance with embodiments, the diamond cutting tool head 11 must be vacuum-brazed to the shank 12, and not sintered. Sintering is a mechanical capture method which does not permit the sharing of atomic bonds, and thus, allows the diamond cutting tool head 11 to become loose in its mount at a microscopic level, significantly impairing its ability to produce minimized roughness and accurate surface figure. In accordance with embodiments, therefore, the diamond cutting tool head 11 is configured to contact the shank 12 only through the braze media of the thermal interface 14 therebetween, where atomic bonds are shared between the diamond cutting tool head 11 and the shank 12. The thermal conductivity of the silver-braze media is greater than that of the shank 12, but less than that of the diamond cutting tool head 11.

In accordance with embodiments, diamond-machining processes where air, coolants, and/or lubricants are directed into the machining interface may be used in conjunction with the cutting tool 10 to further enhance the transfer of heat (about 20 Watts/m²K).

### ADDITIONAL NOTES AND EXAMPLES

Example One may include a cutting tool for ultra-precision machining, comprising: a cutting tool head having a cutting edge to contact a workpiece during operation of the cutting tool, the cutting tool head being composed of a single-crystal diamond material; a shank having a shank body composed of siliconized silicon carbide; and a thermal interface composed of a metal material to form a vacuum-brazed connection between the cutting tool head and the shank body, the thermal interface being configured for thermal and physical contact between the cutting tool head to the shank body, wherein the thermal interface is configured to act as a thermal conductor to transfer heat from the cutting tool head to the shank body, and the shank body is configured to act as a heat sink to transfer or conduct heat from the thermal interface in order that an operational temperature of the cutting edge is less than 482° C.

Example Two may include the cutting tool of Example One, wherein the cutting tool head is mechanically connected to and in thermal communication with the shank via a vacuum-brazed thermal interface.

Example Three may include the cutting tool of Example One, wherein the cutting tool head contacts the holder body at a single plane of contact interface where atomic bonds are shared.

Example Four may include the cutting tool of Example One, wherein the metal material has a thermal conductivity that is greater than the thermal conductivity of a holder material but less than the thermal conductivity of diamond.

Example Five may include the cutting tool of Example One, wherein the metal material comprises a silver alloy.

Example Six may include a cutting tool for ultra-precision machining, comprising: a cutting tool head having a cutting edge to contact a workpiece, the cutting tool head being composed of diamond; a cutting tool head holder upon which the cutting tool head is mounted, the cutting tool head holder being composed of a holder material having a thermal conductivity of at least 225 W/m²K and a modulus of elasticity of not less than 340 GPa; and a thermal interface configured for thermal and physical contact between the cutting tool head to the cutting tool head holder, the thermal interface being composed of a thermal conducting material to form a vacuum-brazed connection between the cutting tool head and the cutting tool head holder, and to also transfer heat from the cutting tool head to the cutting tool head holder in order to maintain an operational temperature of the cutting edge at less than a predetermined temperature.

Example Seven may include the cutting tool of Example Six, wherein the holder material comprises siliconized silicon carbide.

Example Eight may include the cutting tool of Example Six, wherein the predetermined temperature comprises 482° C.

Example Nine may include the cutting tool of Example Six, wherein the cutting tool head contacts the cutting tool head holder at a single contact interface.

Example Ten may include the cutting tool of Example Six, wherein the thermal conducting material comprises a metal material.

Example Eleven may include the cutting tool of Example Ten, wherein the metal material has a thermal conductivity that is greater than the thermal conductivity of the cutting tool tip holder and less than the thermal conductivity of diamond.

Example Twelve may include the cutting tool of Example Eleven, wherein the metal material comprises silver or a silver alloy.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A cutting tool for ultra-precision machining, comprising:
a cutting tool head having a cutting edge to contact a workpiece during operation of the cutting tool, the cutting tool head being composed of a single-crystal diamond material;
a shank having a shank body composed of siliconized silicon carbide; and
a thermal interface composed of a metal material to form a vacuum-brazed connection between the cutting tool head and the shank body, the thermal interface being configured for thermal and physical contact between the cutting tool head to the shank body,
wherein the thermal interface is configured to serve as a thermal conductor to transfer heat from the cutting tool head to the shank body, and the shank body is configured to act as a heat sink to transfer heat from the thermal interface in order that an operational temperature of the cutting edge is less than 482° C.

2. The cutting tool cutting tool of claim 1, wherein the cutting tool head is mechanically connected to and in thermal communication with the shank via a vacuum-brazed thermal interface.

3. The cutting tool cutting tool of claim 1, wherein the cutting tool head contacts the holder body at a single plane of contact interface where atomic bonds are shared.

4. The cutting tool cutting tool of claim 1, wherein the metal material has a thermal conductivity that is greater than the thermal conductivity of a holder material but less than the thermal conductivity of diamond.

5. The cutting tool cutting tool of claim 1, wherein the metal material comprises a silver alloy.

6. A cutting tool for ultra-precision machining, comprising:
a cutting tool head having a cutting edge to contact a workpiece, the cutting tool head being composed of diamond;
a cutting tool head holder upon which the cutting tool head is mounted, the cutting tool head holder being composed of a holder material having a thermal conductivity of at least 225 W/m²K and a modulus of elasticity of not less than 340 GPa; and
a thermal interface configured for thermal and physical contact between the cutting tool head to the cutting tool head holder, the thermal interface being composed of a thermal conducting material to form a vacuum-brazed connection between the cutting tool head and the cutting tool head holder, and to also transfer heat from the cutting tool head to the cutting tool head holder in order to maintain an operational temperature of the cutting edge at less than a predetermined temperature.

7. The cutting tool of claim 6, wherein the holder material comprises siliconized silicon carbide.

8. The cutting tool of claim 6, wherein the predetermined temperature comprises 482° C.

9. The cutting tool of claim 6, wherein the cutting tool head contacts the cutting tool head holder at a single contact interface.

10. The cutting tool of claim 6, wherein the thermal conducting material comprises a metal material.

11. The cutting tool of claim 10, wherein the metal material has a thermal conductivity that is greater than the thermal conductivity of the cutting tool head holder and less than the thermal conductivity of diamond.

12. The cutting tool of claim 11, wherein the metal material comprises a silver alloy.
